(19) United States
(12) Patent Application Publication
(10) Pub. No.: US 2016/0050135 A1
(43) Pub. Date: Feb. 18, 2016

(54) REAL-TIME MEASUREMENT OF USER INTERFACE PERFORMANCE IN A REMOTE DESKTOP ENVIRONMENT

(71) Applicant: International Business Machines Corporation, Armonk, NY (US)

(72) Inventors: Andrzej Kochut, Croton on Hudson, NY (US); Steven J. Mastrianni, Unionville, CT (US); Anca Sailer, Scarsdale, NY (US); Charles O. Schulz, Ridgefield, CT (US)

(21) Appl. No.: 14/460,390

(22) Filed: Aug. 15, 2014

(51) Int. Cl. H04L 12/26

(52) U.S. Cl. CPC H04L 43/106; H04L 43/0858

(57) ABSTRACT

A computer-implemented method or real-time measurement of a user interface performance in a remote desktop environment is provided. The computer-implemented method may include host computer receiving a command data package and a client request time from client computer, where the client request time is a timestamp of a time at which the command data package was sent from client computer to host computer. The computer-implemented method may further include host computer recording the client request time and a request arrival time, where the request arrival time is a timestamp of a time at which the command data package was received by host computer. The computer-implemented method may further include host computer calculating a first traverse time, where the first traverse time is a time difference between the client request time and the request arrival time to determine a real-time measurement of a user interface performance in the remote desktop environment.

### BACKGROUND

The present invention relates generally to remote desktop environments, and more particularly, to a real-time user interface performance during remote desktop access of a remote desktop environment.

A remote desktop environment refers to a software or operating system feature that provides an operating platform for a personal computer's desktop environment to be run remotely on one system, including for instance, a host computer of a personal computing system, or a server computing system, while being displayed on a separate client computer of the personal computing system or the server computing system. Also, remote desktop is typically provided over a network connection using a TCP/IP connection between the host computer and the client computer. For instance, the users interact with their desktop operating system by sending user inputs of the remote desktop over the TCP/IP connection, from the client computer to the host computer.

The assessment of user interaction performance via a remote desktop for popular graphical user interface (GUI) based operating systems has been, at best, qualitative with only a rough correlation between the assessments by different users and different environments. For example, what is an acceptable experience to one user may be deemed totally unacceptable by another user. Some examples of different assessments of users and user environments may include personal work habits, temperament, and emotional state, all of which may play heavily in the perception of performance. This situation has been aggravated by the lack of directly applicable measurements which are indicative of the performance experience. The measurements which are made easily only roughly correlated to real user experiences. For example, network round trip time is commonly used as an indicator of the acceptability of a network connection to support remote access to the desktop. But, the acceptable round trip time is heavily dependent not only on the specific remote presents protocol but also on the application behavior and the user expectations. Network performance measurements are only roughly indicative of the user experience.

### SUMMARY

According to one embodiment of the present invention, a computer-implemented method for determining a real-time user interface performance in a remote desktop environment is provided. The method may include a host computer receiving a command data package from a client computer; the host computer receiving a client request time, wherein the client request time is a timestamp of a time at which the command data package was sent from the client computer to the host computer; the host computer recording the client request time; the host computer recording a request arrival time, wherein the request arrival time is a timestamp of a time at which the command data package was received by the host computer; and the host computer calculating a first traverse time, wherein the first traverse time is a time difference between the client request time and the request arrival time.

According to another embodiment of the present invention, a computer system for determining a real-time user interface performance in a remote desktop environment is provided. The system may include one or more processors, one or more computer-readable memories, one or more computer-readable tangible storage devices and program instructions which are stored on at least one of the one or more storages devices for execution by at least one of the one or more processors via at least one of the one or more memories, the program instructions comprising: program instructions to receive a command data package from a client computer; program instructions to receive a client request time, wherein the client request time is a timestamp of a time at which the command data package was sent from the client computer to a host computer; program instructions to record the client request time; program instructions to record a request arrival time, wherein the client request time is a timestamp of a time at which the command data package was received by the host computer; and program instructions to calculate a first traverse time, wherein the first traverse time is a time difference between the client request time and the request arrival time.

According to yet another embodiment of the present invention, a computer program product for determining a real-time user interface performance in a remote desktop environment is provided. The computer program product may include one or more computer-readable tangible storage devices and program instructions stored on at least one of the one or more storage devices, the program instructions comprising: program instructions to receive a command data package from a client computer; program instructions to receive a client request time, wherein the client request time is a timestamp of a time at which the command data package was sent from the client computer to a host computer; program instructions to record the client request time; program instructions to record a request arrival time, wherein the client request time is a timestamp of a time at which the command data package was received by the host computer; and program instructions to calculate a first traverse time, wherein the first traverse time is a time difference between the client request time and the request arrival time.

### BRIEF DESCRIPTION OF THE SEVERAL VIEWS OF THE DRAWINGS

Novel characteristics of the invention are set forth in the appended claims. The invention will best be understood by reference to the following detailed description of the invention when read in conjunction with the accompanying figures, wherein like reference numerals indicate like components, and:

FIG. 1 is a functional block diagram illustrating a remote desktop environment, in accordance with an embodiment of the present invention.

FIG. 2 is a functional block diagram illustrating program components of a client computer, in accordance with an embodiment of the present invention.

FIG. 3 is a functional block diagram illustrating program components of a host computer, in accordance with an embodiment of the present invention.

FIG. 4 is a flow chart diagram depicting steps performed by the host computer to calculate a first traverse time, in accordance with an embodiment of the present invention.

FIG. 5 is a flow chart diagram depicting steps performed by the host computer to calculate the first traverse time and a second traverse time, in accordance with an embodiment of the present invention.

FIG. 6 is a functional block diagram of components of the host computer according to another embodiment of the present invention.

### DETAILED DESCRIPTION

User experience for personal computer desktop is very interactive where the user makes an input, such as; moves a mouse, clicks the mouse, or types keys on a keyboard and an application makes updates to the display to reflect the input. In traditional desktop environments, this interaction is normally perceptively instantaneous. As soon as the user pressed the key, the corresponding character appears on the screen. This is the result of very short latencies between the input and the application; generous computing resources available to process the input; and very high bandwidth, and low latency between the application and the display. All three of these may be negatively impacted in the remote computing environment.

Further, user experience of any desktop is primarily driven by the time that it takes the computer to respond to user input. For example the time it takes for a press of a key, when the user is typing, until the associated character is displayed on the screen in a word processor window. This interaction can be broken up into 5 components: (1)The time the client takes to interpret the user input (key press for instance) and create and launch the associated packet of data to the host over the network connection; (2) the time the packet takes to transverse the network to the host; (3) the time the host takes to interpret the packet, the application to perform its steps (i.e. place the character in the appropriate frame buffer), and the time it takes the host OS to package up a set of rectangle updates and send them back to the client; (4) the time it takes the rectangle update packets to traverse the network; and (5) the time it takes the client to render the rectangle updates on it's screen.

It may be assumed that (1) and (5) are negligible and do not vary appreciably with load and situation. It may be further assumed that for many command response situations, the time between commands is longer than the total response time and further that as the response time slows down the command rate tends to slow down commensurate with the response time.

These results in a pattern of command response clusters on the network, with each cluster starting with a command packet from the client to the host followed by one or more rectangle update packets from the host to the client. The average time between the command packet and the first response packet at the client end of the network gives a good measure of the total responsiveness of the user interface and is a direct indicator of user experience.

Embodiments of the present invention includes one or more circuits, or subassemblies of circuits, as well as, a system, or computer-implemented methods of operation for real time measurement of user interface performance in a remote desktop environment.

According to at least one embodiment, the proposed system will monitor all traffic on the remote client TCP/IP connection and separate the traffic into command-response clusters. It will then calculate the time between sending the command packet and receiving the first response packet. This time difference will then be averaged in various fashions to determine 1) Nominal response behavior, 2) Current response behavior, and 3) Response behavior trends. The present invention provides a mechanism for comparing nominal behavior of each workstation with the nominal behavior of the overall population, by identifying workstations which exhibit poor user experience. The present invention further provides comparison of the current behavior with the nominal behavior of a specific workstation by identifying when a workstation is experiencing abnormal user experience. Thus, by observing the trend of a workstation, the present invention provides an early warning of impending user experience problems, in accordance with at least one embodiment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like, conventional procedural programming languages such as the “C” programming language, a hardware description language such as VERILOG, or similar programming languages. The program code may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

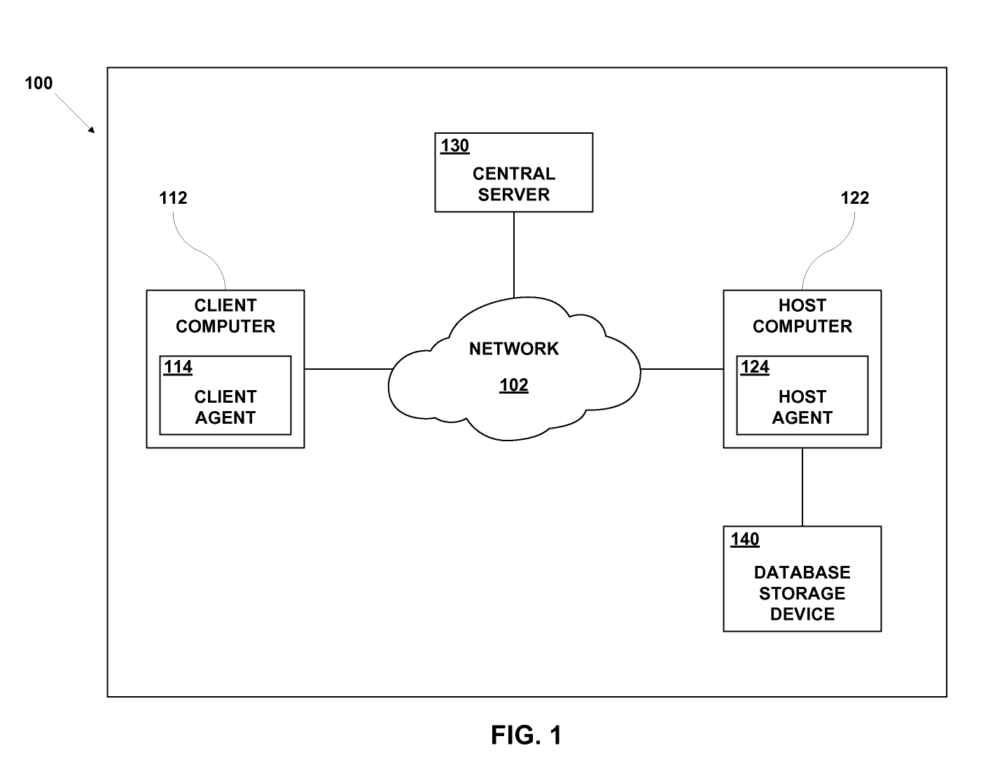

The present invention will now be described in details with reference to the accompanying figures. Referring to FIG. 1, remote desktop environment 100, for real time measurement of user interface performance in a remote desktop environment, is illustrated, in accordance with embodiments of the present invention. Remote desktop environment 100 may include host computer 122, client computer 112, central server 130, and database storage device 140, all interconnected over network 102.

Host computer 122 may be a laptop computer, tablet computer, netbook computer, personal computer (PC), a desktop computer, a personal digital assistant (PDA), a smart phone, or any programmable electronic device that is capable of communicating with client computer 112 via network 102 for performing real time measurement of user interface performance in a remote desktop environment between host and client.

Host computer 122 may also be a server, for example, a mainframe server computer system such as a management server, a web server, or any other electronic device or computing system capable of receiving and sending data. Host computer 122 can also represent a “cloud” of computers interconnected by one or more networks, wherein host computer 122 may be a primary server for a computing system utilizing clustered computers when accessed through network 102.

Host computer 122 includes host agent 124. Host agent 124 can be any type of system application that provides an application interface for registering and recording request/response times or timestamps of data package transmission events. The host agent 124 can also be any type of system application that provides an application interface for calculating time differences between recorded request/response times or timestamps of data package transmission events. A timestamp is sequence of characters or encoded information identifying when a certain event occurred, usually giving date and time of day, sometimes accurate to a small fraction of a second.

According to aspects of the present invention, the timestamps in a remote desktop environment may be times, such as, for example, the event time of creating, sending, receiving, or responding to a data package. The calculation of time differences between the timestamps may be the process of removing (subtracting) a smaller or equal timestamp value from a larger or equal timestamp value if the timestamps occur on the same day. A timestamp value can be the time of day on a twenty-four hour clock (also known as military time), such as, for example, 2 pm on a twelve hour clock is equal to 1400 on a twenty-four hour clock. For example, if the timestamps occur on different days, a 2400 value is added to the later date timestamp and the calculation is then commenced, as previously described.

Client computer 112 may be a laptop computer, tablet computer, netbook computer, personal computer (PC), a desktop computer, a personal digital assistant (PDA), a smart phone, or any programmable electronic device capable of communicating with host computer 122 via network 102. Client computer 112 may include client agent 114. Client agent 114 can be any type of system application that provides an application interface for registering and recording request/response times or timestamps of data package transmission events.

Client agent 114 can also be any type of system application that provides an application interface for calculating time differences between recorded request/response times or timestamps of data package transmission events. The timestamps in a remote desktop environment may be times, such as, for example, the event time of creating, sending, receiving, or responding to a data package. The calculation of time differences between the timestamps may be the process of removing (subtracting) a smaller or equal timestamp value from a larger or equal timestamp value if the timestamps occur on the same day. A timestamp value can be the time of day on a twenty-four hour clock (also known as military time), such as, for example, 2 pm on a twelve hour clock is equal to 1400 on a twenty-four hour clock. If the timestamps occur on different days, a 2400 value is added to the later date timestamp and the calculation is then commenced, as previously described.

For example, in one embodiment, client computer 112 can create and send a command data package having a client request time. Client computer 112 may create the command data package by receiving data from a user input in a client interface, create the command data package based on the data from the user input, send the command data package to the host computer, record the client request time, and send the client request time to the host computer. Client computer 112 can create the data packages periodically, randomly, or event-based creation based on the user input in client interface. Also, the client request time may be recorded by client agent 114. The client request time may be the time at which the command data package is sent from client computer 112.

Central server 130 can be, a central mainframe server system such as a management server, a web server, or any other electronic device, or central computing server system that is capable of receiving and sending data and, also, serving as an intersection for transmitting command/response data packages and timestamps, between host computer 122 and client computer 112. Central server 130 can also represent a “cloud” of computers interconnected by one or more networks, wherein central server 130 is a primary server for a computing system utilizing clustered computers when accessed through network 102. For example, a cloud computing system can be an implementation of an integrated system tool that provides a facility to perform recording timestamps or calculating timestamp differences. Central server 130 may include a central server program. The central server program may receive or record; data packages, timestamps, or timestamp differences from the client computer 112 or the host computer 122. The central server program may also calculate timestamp differences from received or recorded timestamps from client computer 112 or host computer 122.

Database storage device 140 may be any type of storage device, storage server, storage area network, redundant array of independent discs (RAID), cloud storage service, or any type of data storage. The relational model for database management of database storage device 140 may be a database model based on first-order predicate logic. In the relational model of a database, all data may be represented in terms of tuples, grouped into relations. For example, the database storage device 140 may receive data packages, timestamps, or timestamp differences from the client computer 112, the central server 130, or the host computer 122, and store the received data package in measurement files for future retrieval.

Network 102 can include one or more networks of any kind that can provide communication links between various devices and computers connected together within remote desktop environment 100. Network 102 can also include connections, such as wired communication links, wireless communication links, or fiber optic cables. Network 102 can also be implemented as a number of different types of networks, including, for example, a local area network (LAN), wide area network (WAN) or a packet switched telephone network (PSTN), or some other networked system. For example, remote desktop environment 100 can utilize the Internet with network 102 representing a worldwide collection of networks. The term “Internet” as used according to embodiments of the present invention refers to a network or networks that uses certain protocols, such as the TCP/IP protocol, and possibly other protocols such as the hypertext transfer protocol (HTTP) for hypertext markup language (HTML) documents that make up the world wide Web (the web). In general, network 102 can be any combination of connections and protocols that will support communications between host computer 122 and client computer 112 or central server 130, for performing real time measurement of user interface performance in a remote desktop environment between host and client.

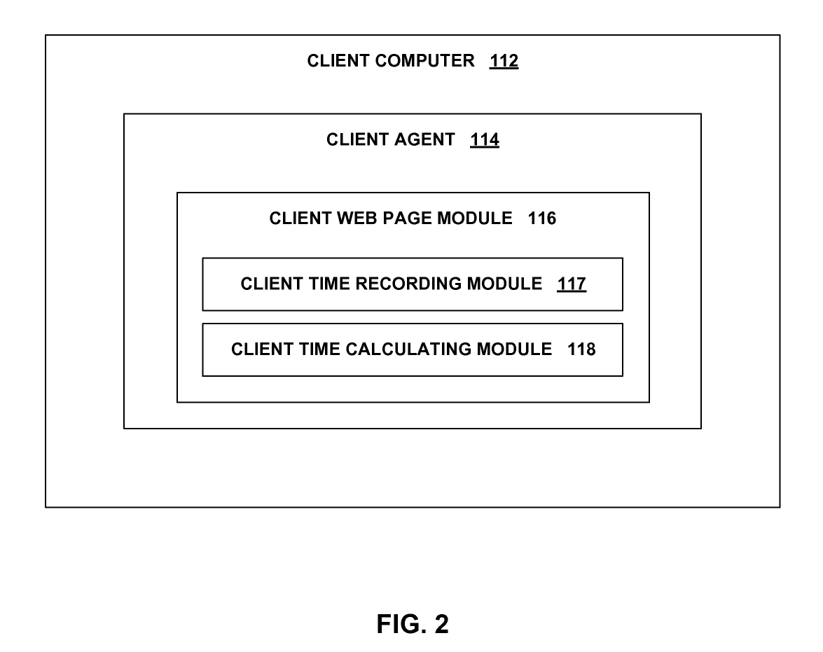

FIG. 2 is a demonstrative illustration of a functional block diagram illustrating program components of the client computer 112, in accordance with an embodiment of the present invention. More specifically, the client computer 112 may include the client agent 114 which may be the computer program that conducts the recording, calculating and transmission of timestamps and datapackages.

Client agent 114 may include, among other things, client web page module 116, client time recording module 117, and client time calculating module 118. Client web page module 116 may be a web browser plugin/add-on that extends the functionality of client agent 114 by adding additional user interface elements to client agent 114, for performing real time measurement of user interface performance in a remote desktop environment between host and client. Client web page module 116 may include program code, such as, Hypertext Markup Language (HTML) code or JavaScript code. Client web page module 116 may include client time recorder module 117 and client time calculating module 118, which may be received in client web page module 116 from the central server program for recording and calculating of timestamps and timestamp differences as described above, with reference to FIG. 1.

Client time recorder module 117 may record timestamps of data packages sent from client computer 112 or timestamps received from host computer 122. Client time calculating module 118 may calculate time differences between timestamps received or recorded by client time recording module 117, as describe above with reference to FIG. 1. For example, the difference in time between sent/received timestamps may indicate a real-time user interface performance. The real-time user interface performance may indicate real-time changes in performance and the calculated difference in times may be recorded for future use or used in real-time.

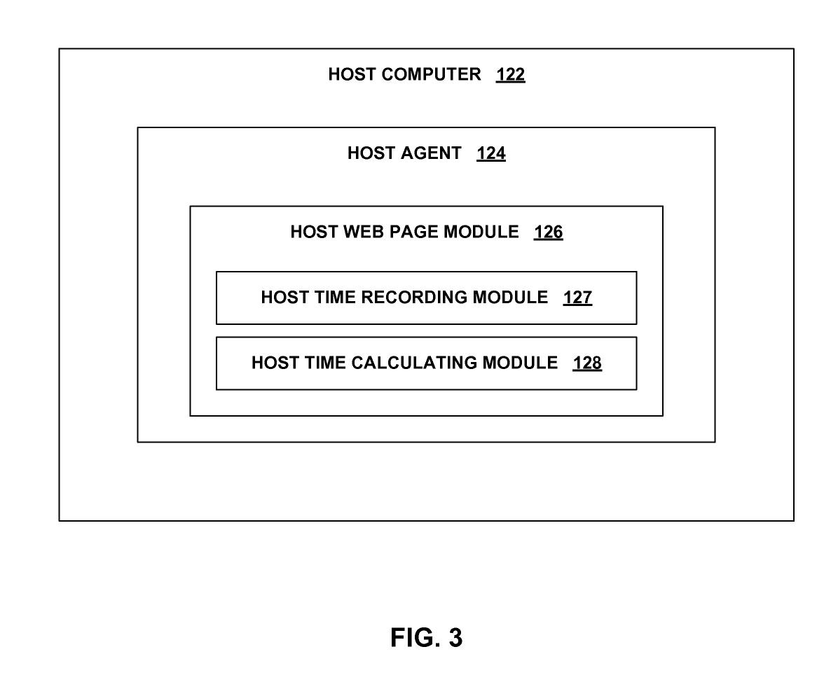

FIG. 3 is a demonstrative illustration of a functional block diagram illustrating program components of the host computer 122 in accordance with an embodiment of the present invention. More specifically, the host computer 122 may include the host agent 124, the host agent 124 may include, among other things, a host web page module 126, a host time recording module 127, and a host time calculating module 128.

The host web page module 126 may be a web browser plugin/add-on that extends the functionality of the host agent 124 by adding additional user interface elements to the host agent 124. The host web page module 126 may include program code, such as, Hypertext Markup Language (HTML) code or JavaScript code. The host web page module 126 may include the host time recorder module 127, which may be received in the host web page module 126 from the central server program. The host time recorder module 127 may record timestamps of data packages sent from the host computer 122 or timestamps received from the client computer 112. The host time calculating module 128 may calculate time differences between timestamps received or recorded by the host time recording module 127. The difference in time between sent/received timestamps may indicate a real-time user interface performance. The real-time user interface performance may indicate real-time changes in performance and the calculated difference in times may be recorded for future use or used in real-time.

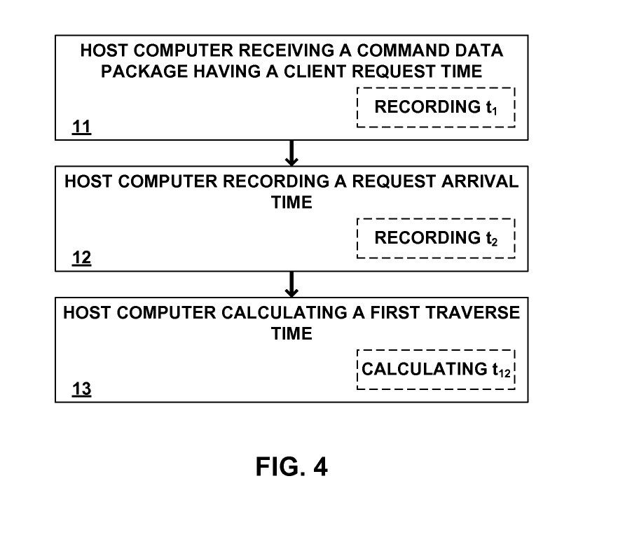

FIG. 4 is a flow diagram depicting steps performed by the host computer 122. More specifically, the host computer 122 may calculate a first traverse time t₁₂ by determining the difference between a client request time t₁ and a request arrival time t₂.

Host computer 122 may receive the command data package which includes client request time t₁ (Step 11). As described above, client request time t₁ may be the time at which the command data package is sent from client computer 112. Host computer 122 may record request arrival time t₂ (Step 12). Request arrival time t₂ may be the time at which the command data package arrived at host computer 122. Host computer 122 may record first traverse time t₁₂ (Step 13). First traverse t₁₂ time may be the difference between client request time t₁ and request arrival time t₂. First traverse time t₁₂ can indicate real-time user interface performance and may indicate real-time changes in performance. One way to use first traverse time t₁₂ is to, for example, compare first traverse time t₁₂ to a separate traverse time (e.g. second traverse time t₃₄ or a network traverse time) to determine the amount of traverse time change; if the change is larger than a desired amount, the network traverse route or relay may change accordingly.

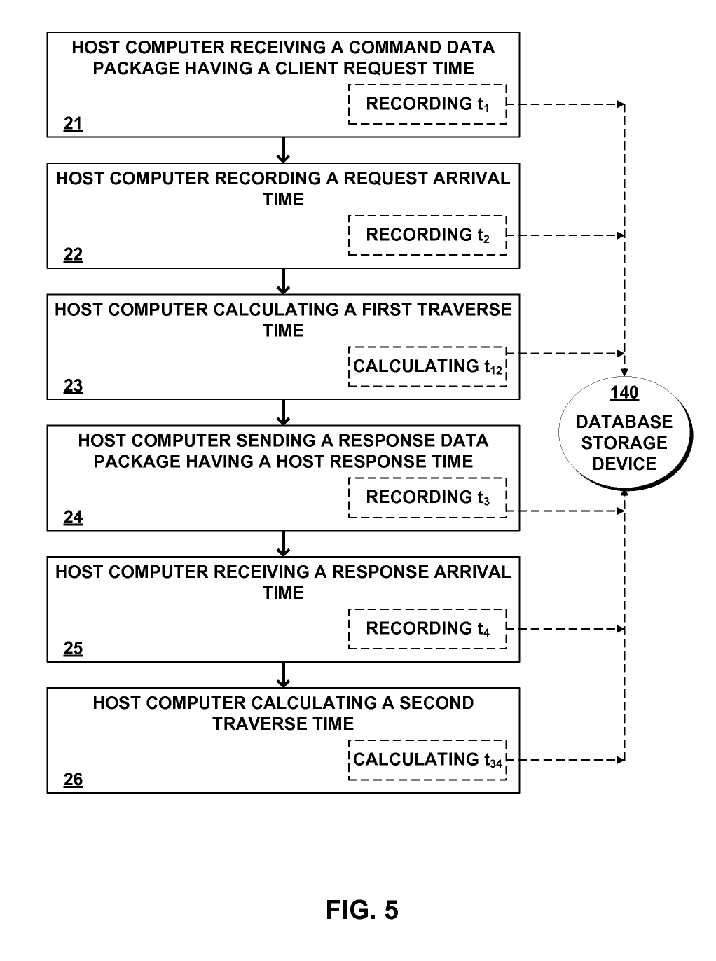

FIG. 5 is a flow diagram depicting steps performed by host computer 122. More specifically, host computer 122 may calculate second traverse time t₃₄ by determining the difference between host response time t₃ and response arrival time t₄.

According to another embodiment, host computer 122 may receive the command data package which includes client request time t₁ (Step 21). As described above, client request time t₁ may be the time at which the command data package is sent from client computer 112. Host computer 122 may record request arrival time t₂ (Step 22). As described above, request arrival time t₂ may be the time at which the command data package arrived at host computer 122. Host computer 122 may record the first traverse time t₁₂ (Step 23). First traverse t₁₂ time may be the difference between client request time t₁ and request arrival time t₂. First traverse time t₁₂ can indicate real-time user interface performance and may indicate real-time changes in performance.

Host computer 122 may create a response data package from the command data package and send the response data package having host response time t₃ (Step 24). Host response time t₃ may be the time at which the response data package is sent from host computer 122. Host computer 122 may receive a response arrival time t₄ (Step 25). Response arrival time t₄ may be the time at which the response data package is received by client computer 112. Finally, Host computer 122 may calculate second traverse time t₃₄ by determining the difference between host response time t₃ and response arrival time t₄ (Step 26). Second traverse time t₃₄ can indicate real-time user interface performance. Second traverse time can be compared to first traverse time t₁₂, or other time differences, to determine changes in performance as described above, with reference to FIG. 4.

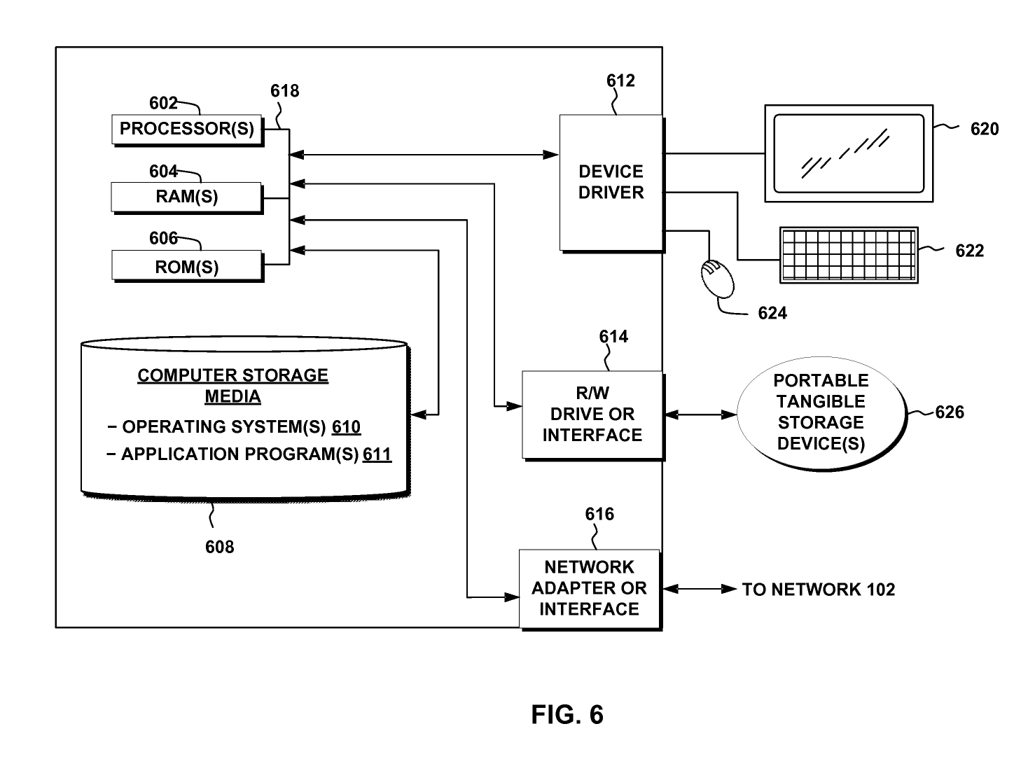

FIG. 6 depicts a block diagram of components of the host computer 122 in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

The host computer 122 may include one or more processors 602, one or more computer-readable RAMs 604, one or more computer-readable ROMs 606, one or more computer readable storage media 608, device drivers 612, read/write drive or interface 614, network adapter or interface 616, all interconnected over a communications fabric 618. Communications fabric 618 may be implemented with any architecture designed for passing data and/or control information between processors (such as microprocessors, communications and network processors, etc.), system memory, peripheral devices, and any other hardware components within a system.

One or more operating systems 610, and one or more application programs 611, for example, the host agent 124, may be stored on one or more of the computer readable storage media 608 for execution by one or more of the processors 602 via one or more of the respective RAMs 604 (which typically include cache memory). In the illustrated embodiment, each of the computer readable storage media 608 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The host computer 122 may also include an R/W drive or interface 614 to read from, and write to, one or more portable computer readable storage media 626. Application programs 611 on the host computer 122 may be stored on one or more of the portable computer readable storage media 626, read via the respective R/W drive or interface 614 and loaded into the respective computer readable storage media 608.

The host computer 122 may also include a network adapter or interface 616, such as a TCP/IP adapter card or wireless communication adapter (such as a 4G wireless communication adapter using OFDMA technology). Application programs 611 on the host computer 122 may be downloaded to the host computer 122 from an external computer or external storage device via a network (for example, the Internet, a local area network or other wide area network or wireless network) and network adapter or interface 616. From the network adapter or interface 616, the programs may be loaded onto computer readable storage media 608. The network may comprise copper wires, optical fibers, wireless transmission, routers, firewalls, switches, gateway computers and/or edge servers.

The host computer 122 may also include a display screen 620, a keyboard or keypad 622, and a computer mouse or touchpad 624. Device drivers 612 interface to display screen 620 for imaging, to keyboard or keypad 622, to computer mouse or touchpad 624, and/or to display screen 620 for pressure sensing of alphanumeric character entry and user selections. The device drivers 612, R/W drive or interface 614 and network adapter or interface 616 may comprise hardware and software (stored on computer readable storage media 608 and/or ROMs 606).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method comprising:
a host computer receiving a command data package from a client computer;
the host computer receiving a client request time, wherein the client request time is a timestamp of a time at which the command data package was sent from the client computer to the host computer;
the host computer recording the client request time;
the host computer recording a request arrival time, wherein the request arrival time is a timestamp of a time at which the command data package was received by the host computer; and
the host computer calculating a first traverse time, wherein the first traverse time is a time difference between the client request time and the request arrival time.

2. The computer-implemented method of claim 1, further comprising:
the host computer creating a response data package;
the host computer sending the response data package to the client computer;
the host computer recording a host response time, wherein the host response time is a timestamp of a time at which the response data package was sent from the host computer;
the host computer receiving a response arrival time, wherein the response arrival time is a timestamp of a time at which the response data package was received by the client computer;
the host computer recording the response arrival time; and
the host computer calculating a second traverse time, wherein the second traverse time is a time difference between the host response time and the response arrival time.

3. The computer-implemented method of claim 1, further comprising:
the client computer receiving data from a user input in a client interface;
the client computer creating the command data package based on the data from the user input;
the client computer sending the command data package to the host computer;
the client computer recording the client request time; and
the client computer sending the client request time to the host computer.

4. The computer-implemented method of claim 1, further comprising:
the host computer storing the client request time in a database storage device; and
the host computer storing the request arrival time in the database storage device.

5. The computer-implemented method of claim 2, further including the steps of:
the host computer storing the host response time in the database storage device; and
the host computer storing the response arrival time in the database storage device.

6. The computer-implemented method of claim 2, further comprising:
the host computer comparing the first traverse time and the second traverse time; and
concluding a real-time user interface performance based on the compared first traverse time and the second traverse time.

7. A computer-implemented method of claim 2, further including the steps of:
transmitting the command data package and the response data package across a network using a central server.

8. A computer system comprising:
one or more processors, one or more computer-readable memories, one or more computer-readable tangible storage devices and program instructions which are stored on at least one of the one or more storages devices for execution by at least one of the one or more processors via at least one of the one or more memories, the program instructions comprising:
program instructions to receive a command data package from a client computer;
program instructions to receive a client request time, wherein the client request time is a timestamp of a time at which the command data package was sent from the client computer to a host computer;
program instructions to record the client request time;
program instructions to record a request arrival time, wherein the client request time is a timestamp of a time at which the command data package was received by the host computer; and
program instructions to calculate a first traverse time, wherein the first traverse time is a time difference between the client request time and the request arrival time.

9. The computer system of claim 8, further comprising:
program instructions to create a response data package;
program instructions to send the response data package to the client computer;
program instructions to record a host response time, wherein the host response time is a timestamp of the time at which the response data package was sent from the host computer;
program instructions to receive a response arrival time, wherein the response arrival time is a timestamp of the time at which the response data package was received by the client computer;
program instructions to record the response arrival time; and
program instructions to calculate a second traverse time, wherein the second traverse time is a time difference between the host response time and the response arrival time.

10. The computer system of claim 8, further comprising:
program instructions to receive data from a user input in a client interface;
program instructions to create a command data package based on the data from the user input;
program instructions to send the command data package to the host computer;
program instructions to record the client request time; and
program instructions to send the client request time to the host computer.

11. The computer system of claim 8, further comprising:
program instructions to store the client request time in a database storage device; and
program instructions to store the request arrival time in the database storage device.

12. The computer system of claim 9, further comprising:
program instructions to store the host response time in the database storage device; and
program instructions to store the response arrival time in the database storage device.

13. The computer system of claim 9, further comprising:
program instructions to compare the first traverse time and the second traverse time; and
program instructions to conclude a real-time user interface performance based on the compared first traverse time and the second traverse time.

14. The computer system of claim 9, further comprising:
program instructions to transmit the command data package and the response data package across a network using a central server.

15. A computer program product comprising:
one or more computer-readable tangible storage devices and program instructions stored on at least one of the one or more storage devices, the program instructions comprising:
program instructions to receive a command data package from a client computer;
program instructions to receive a client request time, wherein the client request time is a timestamp of a time at which the command data package was sent from the client computer to a host computer;
program instructions to record the client request time;
program instructions to record a request arrival time, wherein the client request time is a timestamp of a time at which the command data package was received by the host computer; and
program instructions to calculate a first traverse time, wherein the first traverse time is a time difference between the client request time and the request arrival time.

16. The computer program product of claim 15, further comprising:
program instructions to create a response data package;
program instructions to send the response data package to the client computer;
program instructions to record a host response time, wherein the host response time is a timestamp of the time at which the response data package was sent from the host computer;
program instructions to receive a response arrival time, wherein the response arrival time is a timestamp of the time at which the response data package was received by the client computer;
program instructions to record the response arrival time; and
program instructions to calculate a second traverse time, wherein the second traverse time is a time difference between the host response time and the response arrival time.

17. The computer program product of claim 15, further comprising:
program instructions to receive data from a user input in a client interface;
program instructions to create a command data package based on the data from the user input;
program instructions to send the command data package to the host computer;
program instructions to record the client request time; and
program instructions to send the client request time to the host computer.

18. The computer program product of claim 15, further comprising:
program instructions to store the client request time in a database storage device; and
program instructions to store the request arrival time in the database storage device.

19. The computer program product of claim 16, further comprising:
program instructions to store the host response time in the database storage device; and
program instructions to store the response arrival time in the database storage device.

20. The computer program product of claim 16, further comprising:
program instructions to compare the first traverse time and the second traverse time; and
program instructions to conclude a real-time user interface performance based on the compared first traverse time and the second traverse time.
